(19) United States
(12) Patent Application Publication
(10) Pub. No.: US 2025/0287164 A1
(43) Pub. Date: Sep. 11, 2025

(54) DETERMINATION OF NEEDED ROOM ACOUSTIC CALIBRATION OF AN AUDIO SYSTEM

(71) Applicant: Sony Group Corporation, Tokyo (JP)

(72) Inventors: Peter Shintani, San Diego, CA (US); Gregory Carlsson, San Diego, CA (US)

(73) Assignee: Sony Group Corporation, Tokyo (JP)

(21) Appl. No.: 18/597,753

(22) Filed: Mar. 6, 2024

(51) Int. Cl. H04R 29/00; G06F 3/16; H04R 1/20

(52) U.S. Cl. CPC H04R 29/002; G06F 3/165; H04R 1/20; H04R 2400/01

(57) ABSTRACT

Implementations generally relate to acoustic calibration of an audio system. In some implementations, a method includes generating one or more signals that include sound sequences. The method further includes emitting the one or more signals from one or more speakers in an audio environment. The method further includes receiving the one or more signals at one or more microphones in the audio environment. The method further includes measuring one or more acoustic attributes of the one or more signals that are received at the one or more microphones. The method further includes comparing current values of the one or more acoustic attributes that are measured to stored values of the one or more acoustic attributes. The method further includes determining if recalibration is needed based on the comparing of the current values to the stored values.

### BACKGROUND

Audio systems such as home audio systems typically require calibration to meet user preferences. For example, the placement of furniture, drapes, and wall coverings may affect the acoustics of the environment. Calibration typically occurs when initially setting up the home audio equipment such as the speakers. Users might not recognize the need to re-calibrate the audio system if items such as furniture are moved.

### SUMMARY

Implementations generally relate to an automatic determination of whether room acoustic calibration of an audio system is required. In some implementations, a system includes one or more processors, and includes logic encoded in one or more non-transitory computer-readable storage media for execution by the one or more processors. When executed, the logic is operable to cause the one or more processors to perform operations including: generating one or more signals that include sound sequences; emitting the one or more signals from one or more speakers in an audio environment; receiving the one or more signals at one or more microphones in the audio environment; measuring one or more acoustic attributes of the one or more signals that are received at the one or more microphones; comparing current values of the one or more acoustic attributes that are measured to stored values of the one or more acoustic attributes; and determining if recalibration is needed based on the comparing of the current values to the stored values.

With further regard to the system, in some implementations, the sound sequences are pseudo-random-noise sequences. In some implementations, the one or more acoustic attributes include amplitude. In some implementations, the one or more acoustic attributes include frequency response. In some implementations, the one or more acoustic attributes include phase response. In some implementations, recalibration is needed if a difference between the current values and the stored values are greater than a predetermined threshold. In some implementations, the logic when executed is further operable to cause the one or more processors to perform operations including: setting a length of the sound sequences of the one or more signals below a predetermined length; setting a number samples of the sound sequences above a predetermined number; and setting a volume of the one or more signals that are emitted from the one or more speakers below a predetermined volume. In some implementations, the logic when executed is further operable to cause the one or more processors to perform operations comprising: storing sets of preexisting calibration data, wherein the sets of preexisting calibration data include combinations of states associated with elements in a listening environment; comparing measured calibration data to the sets of preexisting calibration data; and recalibrating an audio system based on the sets of preexisting calibration data.

In some implementations, a non-transitory computer-readable storage medium with program instructions thereon is provided. When executed by one or more processors, the instructions are operable to cause the one or more processors to perform operations including: generating one or more signals that include sound sequences; emitting the one or more signals from one or more speakers in an audio environment; receiving the one or more signals at one or more microphones in the audio environment; measuring one or more acoustic attributes of the one or more signals that are received at the one or more microphones; comparing current values of the one or more acoustic attributes that are measured to stored values of the one or more acoustic attributes; and determining if recalibration is needed based on the comparing of the current values to the stored values.

With further regard to the computer-readable storage medium, in some implementations, the sound sequences are pseudo-random-noise sequences. In some implementations, the one or more acoustic attributes include amplitude. In some implementations, the one or more acoustic attributes include frequency response. In some implementations, the one or more acoustic attributes include phase response. In some implementations, recalibration is needed if a difference between the current values and the stored values are greater than a predetermined threshold. In some implementations, the instructions when executed are further operable to cause the one or more processors to perform operations including: setting a length of the sound sequences of the one or more signals below a predetermined length; setting a number samples of the sound sequences above a predetermined number; and setting a volume of the one or more signals that are emitted from the one or more speakers below a predetermined volume. In some implementations, the instructions when executed are further operable to cause the one or more processors to perform operations comprising: storing sets of preexisting calibration data, wherein the sets of preexisting calibration data include combinations of states associated with elements in a listening environment; comparing measured calibration data to the sets of preexisting calibration data; and recalibrating an audio system based on the sets of preexisting calibration data.

In some implementations, a method includes: generating one or more signals that include sound sequences; emitting the one or more signals from one or more speakers in an audio environment; receiving the one or more signals at one or more microphones in the audio environment; measuring one or more acoustic attributes of the one or more signals that are received at the one or more microphones; comparing current values of the one or more acoustic attributes that are measured to stored values of the one or more acoustic attributes; and determining if recalibration is needed based on the comparing of the current values to the stored values.

With further regard to the method, in some implementations, the sound sequences are pseudo-random-noise sequences. In some implementations, the one or more acoustic attributes include amplitude. In some implementations, the one or more acoustic attributes include frequency response.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example home entertainment environment, according to some implementations.

FIG. 2 is a block diagram of an example network environment for automatically determining whether room acoustic calibration of an audio system is required, which may be used for implementations described herein.

FIG. 3 is an example flow diagram for determining whether room acoustic calibration of an audio system is required, according to some implementations.

FIG. 4 is an example flow diagram for optimizing the determination of whether room acoustic calibration of an audio system is required, according to some implementations.

FIG. 5 is a block diagram of an example network environment, which may be used for some implementations described herein.

FIG. 6 is a block diagram of an example computer system, which may be used for some implementations described herein.

### DETAILED DESCRIPTION

Implementations described herein automatically determine whether room acoustic calibration of an audio system is required. Audio systems such those included in home audio systems typically require calibration upon initial set-up to meet user preferences. Such calibration involves calibration settings that are associated with speakers of a given audio system, and such calibration settings are affected by the placement of various items in the audio system environment. For example, such items may include furniture, drapes, wall coverings, people, etc.

Various changes to the configuration of items in a given environment may have a significant impact on the acoustics of the environment as well as the intended effects of the audio system. Users might not recognize the need to re-calibrate an audio system if items such as furniture are moved, or if user positions are changed.

Implementations described herein automatically detect the need to re-execute calibration. When recalibration is needed, the system may prompt the user to perform the recalibration, or the system may automatically recalibrate the system without user intervention. As described in more detail herein, the system periodically detects the acoustic transfer function of the room (e.g., impulse response, etc.), and determines whether recalibration of the audio system is needed.

As described in more detail herein, in various implementations, a system generates one or more signals that include sound sequences. The system then emits the signals from one or more speakers in an audio environment, and receives the emitted signals at one or more microphones in the audio environment. The system measures one or more acoustic attributes of the signals that are received at the microphones. The types of acoustic attributes may vary, depending on the particular implementation. For example, the acoustic values may include amplitude, frequency response, phase response, or any combination thereof.

The system then compares current values of the one or more acoustic attributes that are measured to stored values of the one or more acoustic attributes. The system then determines if recalibration is needed based on the comparing of the current values to the stored values. The stored values may be different sets of values that correspond to different configurations of the audio environment. In various implementations, the system renders that recalibration is needed if the difference between the current values and the stored values are greater than a predetermined threshold. If recalibration is needed the system may prompt the user to recalibrate the audio system. Alternatively, the system may automatically recalibrate the audio system. For example, if the current values of the acoustic attributes are significantly different from the previous value settings, the system may automatically select a preexisting set of values and recalibrate the audio system to that set of values.

As described in more detail herein, in various implementations, the system decreases a length of the sound sequences of the one or more signals below a predetermined length. The system also increases the number samples of the sound sequences above a predetermined number. This enables the system to adequately measure the acoustic attributes while decreasing the volume of the one or more signals that are emitted from the one or more speakers below a predetermined volume. Decreasing a volume of the one or more signals that are emitted from the one or more speakers is preferred because the signals may be too loud and annoying to the ears of the user.

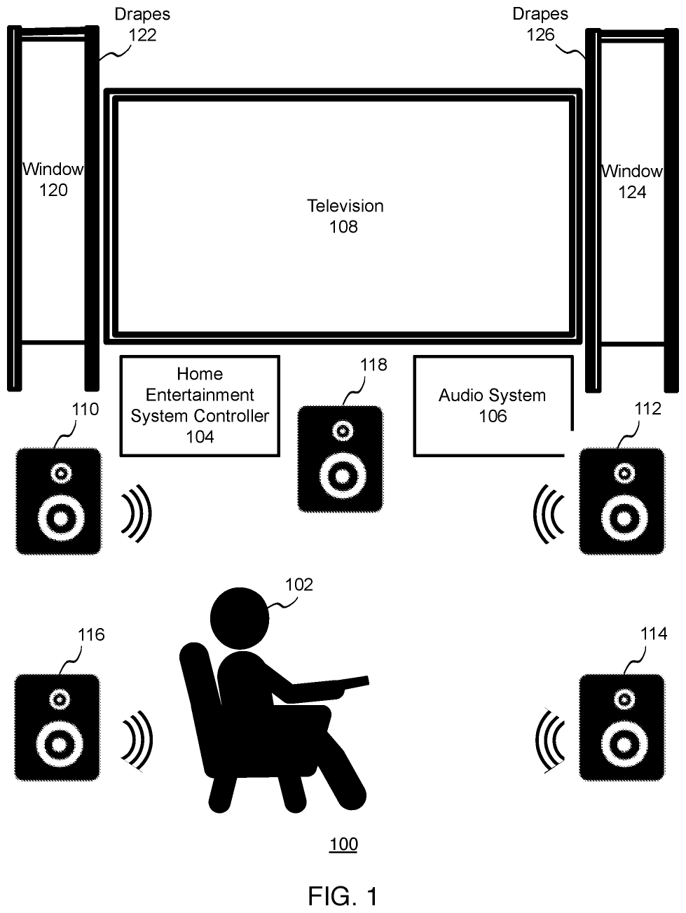

FIG. 1 is a block diagram of an example home entertainment environment 100, according to some implementations. Shown is a user 102 using a home entertainment system that contains various components or media devices. These media devices include, for example, a home entertainment system controller 104, an audio system 106, and a television 108. While home entertainment system controller 104 and/or audio system 106 are shown separately, these components may be integrated into the same media device.

In various implementations, audio system 106 controls various sound devices such as speakers 110, 112, 114, 116, and 118. The various media devices and sound devices of the home entertainment environment are positioned in a given space such as a living room, entertainment room, and the like.

For ease of illustration, FIG. 1 shows one block for each of home entertainment system controller 104, audio system 106, television 108, and shows four blocks for speakers 110, 112, 114, 116, and 118. In other implementations, environment 100 may not have all of the components shown and/or may have other elements including other types of elements instead of, or in addition to, those shown herein. For example, blocks 104, 106, and 108 may represent multiple home entertainment system controllers, audio system, and televisions. Also, there may be any number of speakers. There may also be different types of speakers. The number and types of media devices and sound devices in a given home entertainment system may vary, and will depend on the particular implementation.

Also shown is a window 120 having drapes 122 and a window 124 having drapes 126. In various scenarios, the placement of windows and drapes, as well other items in the environment, such as furniture, wall coverings, etc., affect the acoustics of the environment. For example, the acoustics of the environment would change if drapes 122 and 126 were open versus closed. If open, drapes 122 and 126 would cover less surface area thereby absorbing less sound and would expose respective windows 120 and 124, which reflect sound. Conversely, if closed, drapes 122 and 126 would cover more surface area thereby absorbing more sound and would to some degree shield windows 120 and 124 from sound.

There may be other windows and corresponding drapes (not shown) in the same environment that may affect the acoustics based on their open or closed states. Users might not recognize the need to re-calibrate the audio system if drapes are opened or closed or if items such as furniture in the room are moved or removed. As described in more detail herein, home entertainment system controller 104 automatically determines whether room acoustic calibration of audio system 106 is required.

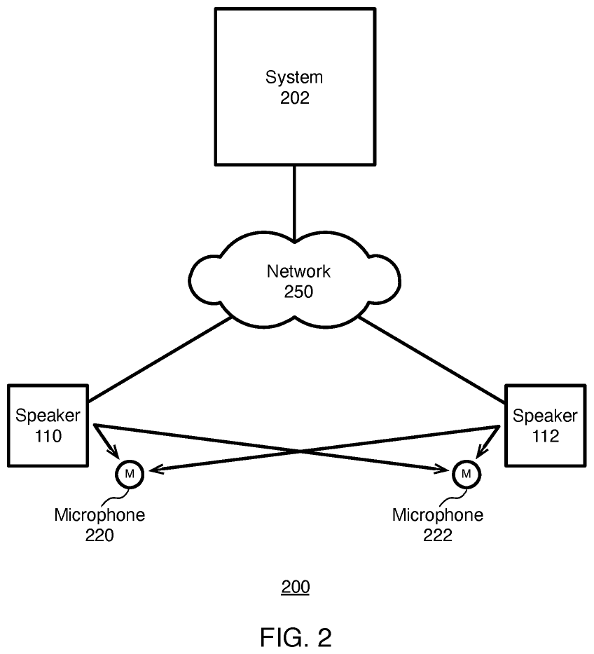

FIG. 2 is a block diagram of an example network environment 200 for automatically determining whether room acoustic calibration of an audio system is required, which may be used for implementations described herein. In various implementations, network environment 200 includes a system 202. System 202 may be used to implement home entertainment system controller 104 and/or audio system 106 of FIG. 1. Network environment 200 also includes speakers 110 and 112 (also shown in FIG. 1). For ease of illustration, two speakers 110 and 112 are shown. There may be any number of speakers included in network environment 200.

Network environment 100 also includes a microphone 220 and a microphone 222. The placement of microphones 220 and 222 may vary, depending on the particular implementation. For example, microphone 220 is shown separately from speaker 110. In some implementations, microphone 220 may be integrated into speaker 110. Similarly, microphone 222 is shown separately from speaker 112. In some implementations, microphone 222 may be integrated into speaker 112.

Network environment 100 may include other microphones not shown. For example, additional microphones may be positioned next to one or more users. One or more microphones may be located on a counter or on stands. A microphone may be located next to or integrated with home entertainment system controller 104 and/or audio system 106.

Speakers 110 and 112 communicate with system 202 and/or may communicate with each other directly or via system 202. Network environment 200 also includes a network 250 through which system 202 and speakers 110 and 120 communicate. Network 250 may be any suitable communication network such as a Bluetooth network, a Wi-Fi network, the Internet, etc.

For ease of illustration, FIG. 2 shows one block for system 202, shows two blocks for speakers 110 and 112, and shows two blocks for microphones 220 and 222. Block 202 may represent multiple systems. As indicated above, each of speakers 110 and 120 may represent a plurality of speakers. Also, each of microphones 220 and 222 may represent a plurality of microphones.

In other implementations, network environment 200 may not have all of the components shown and/or may have other elements including other types of elements instead of, or in addition to, those shown herein. For example, other media devices may be included as optional add-on devices to enhance the entertainment experience. Such media devices may include, for example, high-quality microphones, 360 sound equipment, different types of speakers such as subwoofers, soundbars, etc.

While system 202 performs implementations described herein, in other implementations, any suitable component or combination of components associated with system 202 or any suitable processor or processors associated with system 202 may facilitate performing the implementations described herein.

In the various implementations described herein, a processor of system 202 may cause elements described herein (e.g., sound sequences, measured acoustic attributes video recordings, preexisting calibration settings, and other calibration information, metadata, etc.) to be presented or displayed in a user interface associated with system 202 and/or with one or more media devices including display screens, etc.

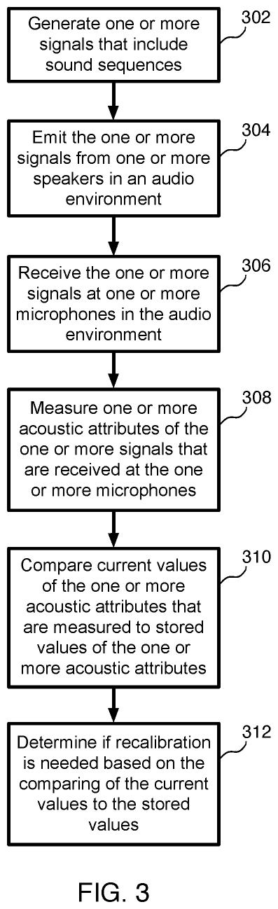

FIG. 3 is an example flow diagram for determining whether room acoustic calibration of an audio system is required, according to some implementations. Referring to both FIGS. 1, 2, and 3, a method is initiated at block 302, where a system such as system 202 generates one or more signals, where the signals include sound sequences. Such sound sequences may include pink or white noise. For example, in various implementations, the sound sequences may be pseudo-random-noise sequences or pseudo-noise (PN) sequences. The PN sequences may be random in during a short time frame, and periodic during a longer time frame. In various implementations, the system generates PN sequences that have a known period, and which are generated by polynomials.

In various implementations, the length of the period of a PN sequence may be determined by the polynomial equation used to generate it. A PN sequence is generated to be long enough to create a useful impulse response measurement of the transfer function between each speaker to the microphone, which is located at a desired listening position. The number length of the PN sequence needs to be long enough to cover the time of flight of the sound from the furthest speaker to the microphone at the desired sampling frequency.

In various implementations, the system utilizes PN sequences because the energy spectrum of random noise from lowest frequency to highest frequency is constant. The energy spectrum may be flat in a vacuum. However, in practice, the energy spectrum would not be flat due to how the elements of the environment absorb and/or reflect sound from each speaker. For example, a given microphone in a given position will detect some sound energy as being higher or lower due to the room characteristics (e.g., window drapes being open or closed, etc.).

In various implementations, the system determines a sufficient length of a given PN sequence for a given room size. In particular, the system determines a sufficient length of the PN sequence to determine the distance of each speaker to given microphone. The length of a given PN sequence may be a fraction of a second, depending on the distance of the speakers from the microphone. For example, sound travels at a given speed for a given elevation, temperature, etc. (e.g., roughly 340 m/s). The maximum distance between a speaker and the listen position for a given use case is known or predetermined. For example, 10 m would be a large listening room for a residential room (e.g., 10 m/340 m/s=29 msec). In this example, a sampling rate of 48 kHz would produce ˜1,400 samples. In another example, a sampling rate of 192 kHz would produce ˜5,600 samples, etc.

In some implementations, in lieu of a PN sequences, the system may utilize an exponential time sweep (e.g., a chirp sound) that sweeps through frequencies (e.g., a quick sweep from low frequency to a high frequency). A chirp sound may also be used to determine the transfer response. In some implementations, a flat energy spectrum of white noise may be used to determine the transfer function of the path between a given speaker and the microphone at the desired listening position.

In some implementations, the system may prompt the user to optionally elect to include an exponential time sweep. While an exponential time sweep it not required to determine whether recalibration is needed, an exponential time sweep enables the system to also detect differences in phase responses of different speakers. Measuring differences in this additional acoustic attribute increases the accuracy of the assessment. Using PN sequences has a benefit if being quiet, unintrusive, and undetectable by the human ear and thus may be used discreetly in the background.

At block 304, the system emits the one or more signals from one or more speakers in an audio environment, such as speakers 110 and 112. The signals from the speakers may also be referred to as test tones. The signals or test tones include PN sequences. The system causes the PN sequence to be emitted by a transducer of each speaker. The system may cause each speaker to emit PN sequences having substantially a one-second-long period, for example. The particular period length may vary, depending on the specific implementation. A pseudo random periodic random noise is random enough for the distance needed to detect the phase delay in the room in a matter of milliseconds. As such, a sequence that is a half a second or a second long is sufficient for detection.

In various implementations, the signals are emitted from the one or more speakers sequentially. For example, the system may cause speaker 110 to emit one or more signals, and then execute the steps described below in block 306 and block 308, and then store the measured results for further processing. The system may subsequently cause speaker 112 to emit one or more signals, and then execute the steps described below in block 306 and block 308, and then store the measured results for further processing. The system may cause any number of speakers to emit the one or more signals, and in any predetermined order.

At block 306, the system receives the one or more signals at one or more microphones in the audio environment, such as microphones 220 and 222. As indicated above, microphones 220 and 222 may be situated in various optional locations. For example, in some implementations, one or more of microphones such as microphones 220 and 222 may be integrated into respective speakers. Alternatively, microphones 220 and/or 222 as well as other microphones may be positioned close to respective speakers, close to one or more users. Microphones may be positioned close to or integrated with home entertainment system controller 104, with audio system 106 (FIG. 1), and/or with any other media device (not shown). Each microphone receives the emitted signals (e.g., PN sequence, etc.) from each speaker for processing.

In various implementations, the system may collect signals for each speaker, buffer signal samples into memory, and average the signals for each speaker over time. Because the PN sequence may be a known predetermined length, the captured sequence may be convolved to find the precise alignment of the sequence. As such, the captured sequences may be added and averaged thereby increasing the signal-to-noise ratio (SNR). In other words, such averaging of random noise over time effectively raises the SNR level up and sufficiently high enough to simulate a sufficiently loud signal in order to determine the frequency characteristics of the room. Hence, a PN sequence may be emitted at a very low and non-objectionable level.

In various implementations, the one or more signals are received from the one or more speakers sequentially. For example, the system may cause microphone 220 to receive one or more signals from speaker 110 and from speaker 112 in a predetermined order, and then execute the step described in block 308, and store the measured results for further processing. The system may subsequently cause microphone 222 to receive one or more signals from speaker 110 and from speaker 112 in a predetermined order, and then execute the step described in block 308, and store the measured results for further processing. The system may cause any number of microphones to receive the one or more signals, and in any predetermined order. When a given speaker emits signals, multiple microphones detected the signals simultaneously. The system is aware of the sequence of speakers emitting signals and thus would determine which speaker is emitting signals for each sample measured.

At block 308, the system measures one or more acoustic attributes of the one or more signals that are received at the one or more microphones. In various implementations, the measurements are performed in association with each speaker and with each microphone. For example, the system may first measure various acoustic attributes at microphone 220, where a set of acoustic attributes are associated with speaker 110 and a set of acoustic attributes are associated with speaker 112. Such acoustic attributes are measured for combinations of each microphone and the various speakers in the audio system.

In various implementations, the system determines acoustic attributes of the one or more signals based on a measured acoustic transfer function of the room, including impulse responses. As indicated herein, the sequence of speakers emitting sounds is known. As such, the system knows what speaker is emitting sounds, and the system may ascertain the location of different speakers positioned at different parts of the room based on the characteristics of the sound from each speaker.

In various implementations, the acoustic attributes may include amplitude. The system detects differences in the amplitudes of the signals emitted by the respective speakers, relative to each other within the environment.

In various implementations, the acoustic attributes may include frequency response, including frequency delays. In various implementations, the transfer function between the microphone and each speaker at desired listening locations will provides the frequency response and provides the time of flight (e.g., the time the sound takes to travel from a given speaker to the microphone). This is sufficient for the audio system to correctly set the audio equalizer for that speaker, and the correct delay.

In various implementations, the acoustic attributes may include phase response, including phase delays. In some implementations, the acoustic attributes may include impulse response. The system may use an impulse response to determine the transfer function between the speaker to microphone accounting for the room. A change in one of the acoustic attributes of amplitude, frequency response, phase response, and impulse response indicates a change in the other attributes.

At block 310, the system compares current values of the one or more acoustic attributes that are measured to stored values of the one or more acoustic attributes. In various implementations, the system may ascertain the location and positions of the speakers relative to the microphone positions. In various implementations, the system may compare changes in acoustic attributes for any one or more of the acoustic attributes. Hence, the need to recalibrate the audio system may be based on any one more of the acoustic attributes. However, the more of these acoustic attributes that are measured and compared, the more accurate the assessment will be whether to recalibrate the system.

At block 312, the system determines if recalibration is needed based on the comparing of the current values to the stored values. For example, the system automatically selects one or more previously stored calibration values. The system compares the currently detected values of one or more acoustic attributes to the previously stored calibration values. The system then detects certain deterministic changes such values, which are indicative of changes to the acoustics of the listening environment.

In various implementations, the baseline for comparison may be the set of calibration values of the previous calibration setting. The measurements need be only accurate enough to determine that the configuration and/or state of the room has changed. In an example scenario, signals from one speaker and detection by one microphone may be sufficient to determine if there is a change that warrants recalibration. In practice, signals from more speakers and detection by more microphones will produce more accurate assessments of the need to recalibrate the audio system.

In various implementations, recalibration is needed if a difference between the current values and the stored values are greater than a predetermined threshold. The predetermined threshold may vary, depending on the particular implementation. If recalibration is needed, in some implementations, the system may prompt the user to recalibrate the audio system as the user had done upon the initial or previous calibration process. In some implementations, the system may utilize an application on a smart phone and/or a particular media device to enable or assist the user in recalibrating the audio system.

In some implementations, the system may automatically recalibrate the audio system without user intervention. In such a scenario, the system may compare the current values to previous stored calibration values to determine the closest match or best fit. In practice, the values from the measurements are not 100% repeatable, which is why the closest match is sufficient. Once the system determines the closest match, the system may switch to the values of that previous calibration.

In various implementations, the system stores multiple sets of preexisting calibration data, where the sets of preexisting calibration data include several combinations of states associated with elements in a listening environment. For example, if the listening environment or room has elements such as one door and one window with drapes, the door may be open or closed. The window may be open or closed. The drapes may be open or closed. This results in 8 possible combinations. As such, the system may be trained to store the 8 possible room calibrations, each having a different and unique combination. The system may be trained to detect certain deterministic changes to the listening environment.

In various implementations, the system compares measured calibration data to the sets of preexisting calibration data. The system determines if any of the preexisting calibrations or combinations correspond to the latest automatic measurement when the system was turned on, or if the user asked the system to confirm the room characteristics. If so, the system refers to the previously stored calibration. In various implementations, the system recalibrates the audio system based on the sets of preexisting calibration data if the measured calibration data matches calibration data associated with one of the sets of preexisting calibration data. For example, when one of the 8 room settings is detected by the system, the system may automatically select the previously stored room calibration data and recalibrate the audio system accordingly.

Such an embodiment is beneficial in that the automatic room detection need not be an elaborate and precise calibration. Rather, it is sufficient for the system to determine which of the previously stored calibrations to pull out of memory. In various implementations, the system may perform checks to determine whether recalibration is needed periodically (e.g., one or more times a week, one or more times a day, etc.). The times and frequency of checks may vary, and will depend on the particular implementation.

In the example implementation above, if the automatic calibration data matches stored preexisting calibration data, the system may select that corresponding preexisting calibration data to use to recalibrate the audio system. In some implementations, if the automatic calibration check does not indicate a match between the currently measured calibration data to one of the sets of stored preexisting calibration data, the system interprets this mis-match as a new room set up. As such, in various implementations, based on the sets of preexisting calibration data, the system recalibrates the audio system if the measured calibration data does not match calibration data associated with one of the sets of preexisting calibration data, where the system may execute a more thorough calibration. The techniques for executing a new thorough calibration may vary, and will depend on the particular implementation.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

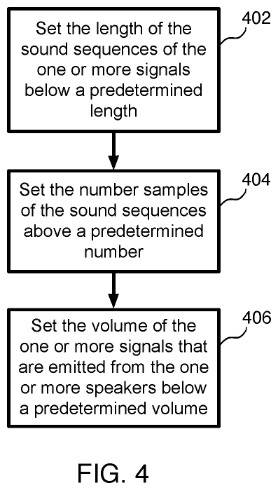

FIG. 4 is an example flow diagram for optimizing the determination of whether room acoustic calibration of an audio system is required, according to some implementations. Referring to both FIGS. 1 and 4, a method is initiated at block 402, where a system such as system 102 sets the length of the sound sequences of the one or more signals below a predetermined length. The predetermined length may vary, depending on the particular implementation. For example, a corner of a typical residential listening room is likely to be less than 10 m to a nominal listening position near the middle of the room. This would imply that the diagonal of the room would be 20 m (66 ft), for example. In various implementations, to reduce the volume level of the emitted signal, the system may take an average of multiple signals since the PN sequences are periodic.

At block 404, the system sets the number samples of the sound sequences above a predetermined number. The predetermined number may vary, depending on the particular implementation. By increasing the number of samples, the emitted volume level of the PN sequence may be lowered by 20 dB or more, for example. Conventional test signals or tones may be annoying to the ears of a user. Here, in various implementations, because the PN sequence is random, once the volume level drops to a white noise level, it is very difficult to discern by the human ear. In other words, because the sound becomes effectively inaudible to the user, the system may increase the number of samples, repeating them continuously, undetected by the user. Because the volume level is lowered, more time is needed to average the signal samples in order to bring the average of signals to a noise ratio sufficiently high enough for the processing.

A consideration or drawback is that the detection time will increase. Since most audio systems require time to settle and also time to start their playback, the system may utilize a mute time for detection. Or, the system may extend the mute time. In various scenarios, the lower the PN sequence sound level, the more error in the transfer function that is calculated. As such, averaging the PN sequence increases the SNR, where two samples double the SNR. For example, if two samples provide 3 dB), four samples would provide 6 dB. Because each measurement time is 30 msec or so, about 1 second of measurement would be about 32 PN sequences being averaged. As such, the SNR improvement would be about 15 dB. This may be not enough to make the PN training sequence undiscernible. Two seconds or more of measurement of the PN sequence sound level may be down to 20 dB, for example.

At block 406, the system sets the volume of the one or more signals that are emitted from the one or more speakers below a predetermined volume.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, the system determines if recalibration is needed based on the comparing of the current configuration of items of a given environment to previous configurations of the items in the environment. The system may perform assessments of the environment automatically without human intervention. The system may also adjust the accuracy of such assessments by varying the acoustic attributes being measured.

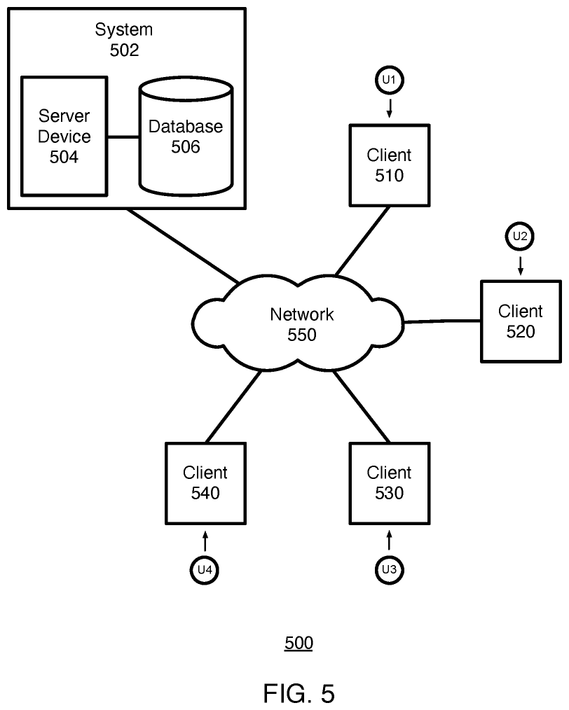

FIG. 5 is a block diagram of an example network environment 500, which may be used for some implementations described herein. In some implementations, network environment 500 includes a system 502, which includes a server device 504 and a database 506. For example, system 502 may be used to implement system 202 of FIG. 2, as well as to perform implementations described herein. Network environment 500 also includes client devices 510, 520, 530, and 540, which may communicate with system 502 and/or may communicate with each other directly or via system 502. Network environment 500 also includes a network 550 through which system 502 and client devices 510, 520, 530, and 540 communicate. Network 550 may be any suitable communication network such as a Wi-Fi network, Bluetooth network, the Internet, etc.

For ease of illustration, FIG. 5 shows one block for each of system 502, server device 504, and network database 506, and shows four blocks for client devices 510, 520, 530, and 540. Blocks 502, 504, and 506 may represent multiple systems, server devices, and network databases. Also, there may be any number of client devices. In other implementations, environment 500 may not have all of the components shown and/or may have other elements including other types of elements instead of, or in addition to, those shown herein.

While server device 504 of system 502 performs implementations described herein, in other implementations, any suitable component or combination of components associated with system 502 or any suitable processor or processors associated with system 502 may facilitate performing the implementations described herein.

In the various implementations described herein, a processor of system 502 and/or a processor of any client device 510, 520, 530, and 540 cause the elements described herein (e.g., information, etc.) to be displayed in a user interface on one or more display screens.

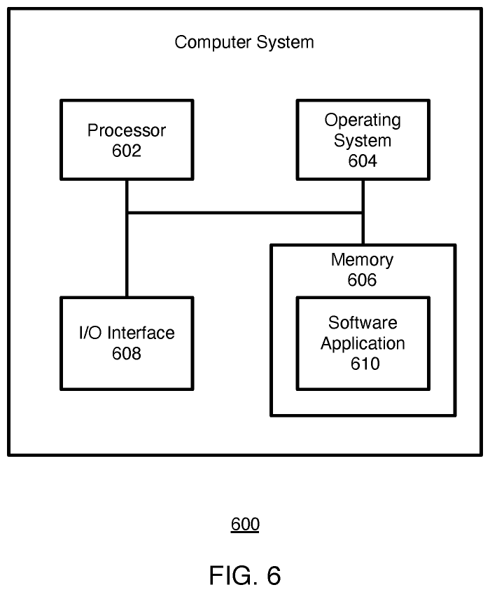

FIG. 6 is a block diagram of an example computer system 600, which may be used for some implementations described herein. For example, computer system 600 may be used to implement server device 504 of FIG. 5 and/or system 202 of FIG. 2, as well as to perform implementations described herein. In some implementations, computer system 600 may include a processor 602, an operating system 604, a memory 606, and an input/output (I/O) interface 608. In various implementations, processor 602 may be used to implement various functions and features described herein, as well as to perform the method implementations described herein. While processor 602 is described as performing implementations described herein, any suitable component or combination of components of computer system 600 or any suitable processor or processors associated with computer system 600 or any suitable system may perform the steps described. Implementations described herein may be carried out on a user device, on a server, or a combination of both.

Computer system 600 also includes a software application 610, which may be stored on memory 606 or on any other suitable storage location or computer-readable medium. Software application 610 provides instructions that enable processor 602 to perform the implementations described herein and other functions. Software application may also include an engine such as a network engine for performing various functions associated with one or more networks and network communications. The components of computer system 600 may be implemented by one or more processors or any combination of hardware devices, as well as any combination of hardware, software, firmware, etc.

For ease of illustration, FIG. 6 shows one block for each of processor 602, operating system 604, memory 606, I/O interface 608, and software application 610. These blocks 602, 604, 606, 608, and 610 may represent multiple processors, operating systems, memories, I/O interfaces, and software applications. In various implementations, computer system 600 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
generating one or more signals that include sound sequences;
emitting the one or more signals from one or more speakers in an audio environment;
receiving the one or more signals at one or more microphones in the audio environment;
measuring one or more acoustic attributes of the one or more signals that are received at the one or more microphones;
comparing current values of the one or more acoustic attributes that are measured to stored values of the one or more acoustic attributes; and
determining if recalibration is needed based on the comparing of the current values to the stored values.

2. The system of claim 1, wherein the sound sequences are pseudo-random-noise sequences.

3. The system of claim 1, wherein the one or more acoustic attributes comprise amplitude.

4. The system of claim 1, wherein the one or more acoustic attributes comprise frequency response.

5. The system of claim 1, wherein the one or more acoustic attributes comprise phase response.

6. The system of claim 1, wherein recalibration is needed if a difference between the current values and the stored values are greater than a predetermined threshold.

7. The system of claim 1, wherein the logic when executed is further operable to cause the one or more processors to perform operations comprising:
setting a length of the sound sequences of the one or more signals below a predetermined length;
setting a number samples of the sound sequences above a predetermined number; and
setting a volume of the one or more signals that are emitted from the one or more speakers below a predetermined volume.

8. The system of claim 1, wherein the logic when executed is further operable to cause the one or more processors to perform operations comprising:
storing sets of preexisting calibration data, wherein the sets of preexisting calibration data include combinations of states associated with elements in a listening environment;
comparing measured calibration data to the sets of preexisting calibration data; and
recalibrating an audio system based on the sets of preexisting calibration data.

9. A non-transitory computer-readable storage medium with program instructions stored thereon, the program instructions when executed by one or more processors are operable to cause the one or more processors to perform operations comprising:
generating one or more signals that include sound sequences;
emitting the one or more signals from one or more speakers in an audio environment;
receiving the one or more signals at one or more microphones in the audio environment;
measuring one or more acoustic attributes of the one or more signals that are received at the one or more microphones;
comparing current values of the one or more acoustic attributes that are measured to stored values of the one or more acoustic attributes; and
determining if recalibration is needed based on the comparing of the current values to the stored values.

10. The computer-readable storage medium of claim 9, wherein the sound sequences are pseudo-random-noise sequences.

11. The computer-readable storage medium of claim 9, wherein the one or more acoustic attributes comprise amplitude.

12. The computer-readable storage medium of claim 9, wherein the one or more acoustic attributes comprise frequency response.

13. The computer-readable storage medium of claim 9, wherein the one or more acoustic attributes comprise phase response.

14. The computer-readable storage medium of claim 9, wherein recalibration is needed if a difference between the current values and the stored values are greater than a predetermined threshold.

15. The computer-readable storage medium of claim 9, wherein the instructions when executed are further operable to cause the one or more processors to perform operations comprising:
setting a length of the sound sequences of the one or more signals below a predetermined length;
setting a number samples of the sound sequences above a predetermined number; and
setting a volume of the one or more signals that are emitted from the one or more speakers below a predetermined volume.

16. The computer-readable storage medium of claim 9, wherein the instructions when executed are further operable to cause the one or more processors to perform operations comprising:
storing sets of preexisting calibration data, wherein the sets of preexisting calibration data include combinations of states associated with elements in a listening environment;
comparing measured calibration data to the sets of preexisting calibration data; and
recalibrating an audio system based on the sets of preexisting calibration data.

17. A computer-implemented method comprising:
generating one or more signals that include sound sequences;
emitting the one or more signals from one or more speakers in an audio environment;
receiving the one or more signals at one or more microphones in the audio environment;
measuring one or more acoustic attributes of the one or more signals that are received at the one or more microphones;
comparing current values of the one or more acoustic attributes that are measured to stored values of the one or more acoustic attributes; and
determining if recalibration is needed based on the comparing of the current values to the stored values.

18. The method of claim 17, wherein the sound sequences are pseudo-random-noise sequences.

19. The method of claim 17, wherein the one or more acoustic attributes comprise amplitude.

20. The method of claim 17, wherein the one or more acoustic attributes comprise frequency response.
